(19) United States
(12) Patent Application Publication
(10) Pub. No.: US 2025/0282973 A1
(43) Pub. Date: Sep. 11, 2025

(54) Chalk for people of colors

(71) Applicant: Trina Wiggins, Las Vegas, NV (US)

(72) Inventor: Trina Wiggins, Las Vegas, NV (US)

(21) Appl. No.: 18/595,490

(22) Filed: Mar. 5, 2024

(51) Int. Cl. C09D 13/00

(52) U.S. Cl. CPC C09D 13/00

(57) ABSTRACT

The method relates to a revolutionary-colored chalk formula that caters to all skin tones! This innovative product boasts a user-friendly and eco-friendly design and offers a wide variety of colors to choose from. Not only that, but its long-lasting properties make it a reliable choice for all your coloring needs.

### Copyright Notice

A portion of the disclosure of this patent document contains material which is subject to copyright protection. The copyright owner has no objective to the facsimile reproduction by anyone of the patent disclosure, as t appears in the Patent and Trademark Office patent files or records, but otherwise reserves all copyrights whatsoever.

### BACKGROUND

### Field of the Invention

The present invention is related to chalk and more particularly related to chalk, designed especially for all skin tones.

### Description of the Related Art

chalk is a white substance that seemingly is able to withstand tonnes of construction and disruption, while also crumbling on a blackboard to leave layers behind. Chalk is used in our daily lives, as it has either played a part in food production, medication or for daily activities. So, if the properties of chalk are so varied, in accordance with the use that it has been designed for, have we fully acknowledged the importance of chalk? To add, while chalk may be more familiar to some, as a substance used to write on blackboards within classrooms, does anybody know what it actually is?

From a medical perspective, chalk is also known as calcium carbonate, which has been used to relieve heartburn since 1930. Calcium carbonate is found in antacids, which is chewed to provide relief for gastro-intestinal discomfort. Calcium carbonate is a basic and insoluble compound, therefore, when swallowed, calcium carbonate will not be absorbed into the gut, rather, it will react with excess hydrochloric acid in the stomach and result in a neutralisation reaction:

CaCO3(aq)+HCl(aq)->CaCl2(s)+H2O(1)+CO2(g) in which the carbonate (CO32-) ions from the CaCO3, will react with hydrogen (H+) from HCl and therefore prevent the oesophagus from being harmed by the stomach acid. Antacids are the oldest and most effective form of treatment for heartburn, which is the reflux of stomach acid from the stomach into the oesophagus, which results in a burning sensation as the oesophagus lining is not suited for withstanding stomach acid, unlike the stomach lining.

Antacids are projected to reach a global market value of US$ 10.5 billion by 2027. This clearly shows the prominence of chalk in the medical world, as well as having a hold in the economic world, due to the growing Global Antacids Market.

In terms of agriculture, chalk is used to neutralise the pH of the soil. Soil can become acidic due to excess acidic rainfall and leaching, as excess water is an effective agent for removing basic ions over long periods of time. Moreover, soil may become acidic due to organic matter decay. When decaying, this matter produces H+ ions which are responsible for acidity. An example of acidic products due to decay is CO2 produced by decaying matter which will react with the water in the soil and produce carbonic acid (which is also found in acid rain). The collection of the acids formed due to the decay of organic material could lead to a decrease in pH of soil, therefore causing it to become acidic.

In daily life, toothpaste is used by a large percentage of the world, however, it may not be known that toothpaste usually contains a small amount of chalk. In the 1850s, John Harris added chalk as an ingredient into toothpaste with the aim of a more efficient cleaning agent than soap. The calcium carbonate is a mild abrasive used to rub away stains and debris from the teeth, however, it is softer than tooth enamel, which allows it to clean the teeth without causing any erosion or damage to them. Moreover, the calcium carbonate is insoluble, which allows it to be used against the teeth as an abrasive, without dissolving in the saliva in the mouth, ensuring it is safe to be put into our mouths.

By looking at prior art multiple advancements have been seen. For instance, a U.S. Pat. No. 5,352,279A relates to a washable pavement chalk composition. A washable pavement chalk composition comprises a particulate such as powdered calcium carbonate and a binder such as rice starch. The composition is used in a liquid form, therefore preferably also comprising water. One or more colorants may be used in the composition to provide different colored compositions.

A WO patent 2,011,141936A1 relates to a novel dustless chalk and process of making the same. The invention relates to a dustless chalk, having cylindrical shape with specified length and diameter. A process of making dustless chalk comprises step of preparing calcium sulphate di-hydrate 20% to 60% and Calcium sulphate hemi-hydrate 30% to 70% mixing with poly hydro compound. The said composition is treated with air removing agent while chalk is made in the known way the said composition is treated with air removing agent maintain uniformity and strength of chalk. Also the said composition is treated with poly-hydro compound to prevent release of dust particle.

A CN patent 1,024,42106A relates to Chalky teaching chalk and manufacturing method thereof. The invention discloses chalky teaching chalk and a manufacturing method thereof. The chalky teaching chalk comprises the following materials in percent by weight: 10-50 percent of chalky powder, 1-10 percent of titanium dioxide and the balance of gypsum powder. The manufacturing method comprises the following steps of: firstly preparing a powder material according to the matching ratio, adding water according to 70-100% of the total weight of the powder material, manufacturing paste, then carrying out injection molding, demolding, drying and obtaining a finished product. The invention has the characteristics that no toxicity and smell are not generated, no dust flies when a user writes on a blackboard or clean the blackboard, the air in class is not polluted, the body health of teachers and students are not influenced, and the occurrence rate of occupational diseases of the teachers is greatly reduced.

A CN patent 1,024,85815A relates to Dust-free chalk. The invention relates to dust-free chalk, which is made from the following raw materials: calcium carbonate, gypsum powder, color paste, a polyvinyl alcohol water solution and water. And the chalk is prepared by: mixing and stirring all components uniformly, conducting extrusion molding and drying, then carrying out dip coating with the polyvinyl alcohol water solution, and finally performing drying. Compared with prior art, the chalk of the invention undergoes dip coating and can reach dust-free requirements. The chalk product provided in the invention has the advantages of less dust, legible handwriting, and smooth writing.

There are multiple solutions that have been presented in prior art. However, these solutions are limited and restricted to their conventional systems. The current invention is focused on presenting a range of chalks in various shades that complement different skin tones, replacing the conventional white chalk with a more appropriate alternative.

None of the previous inventions and patents, taken either singly or in combination, is seen to describe the instant invention as claimed. Hence, the inventor of the present invention proposes to resolve and surmount existent technical difficulties to eliminate the aforementioned shortcomings of prior art.

### SUMMARY

In light of the disadvantages of the prior art, the following summary is provided to facilitate an understanding of some of the innovative features unique to the present invention and is not intended to be a full description. A full appreciation of the various aspects of the invention can be gained by taking the entire specification, claims and abstract as a whole.

The primary desirable object of the present invention is to provide a novel and improved method for preparing and presenting chalk assembly that comes in various skin tones.

It is also the primary objective of the invention to provide a chalk assembly designed for people of color, with brown skin tones

It is another objective of the invention to provide dust-free chalk that works smoothly.

It is also the object of the invention to provide an advanced chalk that is user friendly and supports all skin types.

Other aspects, advantages and novel features of the present invention will become apparent from the detailed description of the invention when considered in conjunction with the accompanying claims.

This Summary is provided merely for purposes of summarizing some example embodiments, so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### DETAILED DESCRIPTION

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

The present invention is directed to an advanced assembly of chalk that is developed keeping in view of people of all skin tones and is safe to use.

Chalk in stick form has been known for some time. In one well known format, the chalk comes in a package of several sticks, each of a different color. Chalk is advertised as washable, implying that it will wash off of pavement by rain or an equivalent low-pressure water stream, without the need for any scrubbing or abrasive action.

Artists, particularly young children, greatly enjoy making drawings with such chalk. Since the chalk is washable, it is used excessively by people from all walks of life.

Accordingly, the invention provides the dustless chalk, having a cylindrical shape with specified length and diameter, made of compositions comprising: calcium sulphate di-hydrate 20% to 60% and Calcium sulphate hemi-hydrate 30% to 70% mixed with poly hydro ccrr.pound; the said composition is treated with air removing agent to maintain uniformity and strength of chalk.

Accordingly, invention also provides a process of making dustless chalk comprising step of:
a. gypsum heated between 100° C. and 150°° C. (302° F.) partially dehydrates the mineral by driving off approximately 75% of the water contained in its chemical structure to form calcium sulphate hemi hydrate;
b. the said calcium sulphate hemi hydrate 30% to 70% of step (a) is mixed with the calcium sulphate di-hydrate 20% to 60%
c. adding the poly-hydro compound to the said mixer of step (b);
d. thoroughly mixing the said mixture of step (c) in a mixing apparatus in the known way;
e. preparing a slurry of the said mixture of step (d);
f. adding an air-removing agent to the said slurry of step (e);
g. pouring the said slurry material of step (f) in a well-prepared mould for partial setting;
h. ejection of chalks by pressing the ejection rods;
i. collection of chalks formed in step (h) in a tray;
j. the drying of the said chalks of step (i) in the tray;
k. the packing of the said dried chalks of step (j) and ready for dispatch.

While a specific embodiment has been shown and described, many variations are possible. With time, additional features may be employed. The particular shape or configuration of the platform or the interior configuration may be changed to suit the system or equipment with which it is used.

Having described the invention in detail, those skilled in the art will appreciate that modifications may be made to the invention without departing from its spirit. Therefore, it is not intended that the scope of the invention be limited to the specific embodiment illustrated and described. Rather, it is intended that the scope of this invention be determined by the appended claims and their equivalents.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

1. A chalk in various skin tones comprising:
a) powdered calcium carbonate and
b) rice starch.

2. The chalk composition of claim 1, wherein further comprises a colorant.

3. The chalk composition of claim 1, wherein further comprises of a variety of skin tones.

4. The chalk composition of claim 1, wherein the user can select chalk that matches his/her skin tone as compared to traditional white chalk.

5. The chalk composition of claim 1, wherein the chalk is skin-friendly.

6. The chalk composition of claim 1, wherein the chalk is environment friendly.
